(19) United States
(12) Patent Application Publication
(10) Pub. No.: US 2022/0230558 A1
(43) Pub. Date: Jul. 21, 2022

(54) Coding Education System

(71) Applicant: INDUSTRY-ACADEMIC COOPERATION OF FOUNDATION OF SUNCHON NATIONAL UNIVERSITY, Suncheon-si (KR)

(72) Inventor: Hyun SIM, Suncheon-si (KR)

(21) Appl. No.: 17/713,175

(22) Filed: Apr. 4, 2022

Related U.S. Application Data
(63) Continuation of application No. PCT/KR2020/013345, filed on Sep. 29, 2020.

(30) Foreign Application Priority Data
Oct. 2, 2019 (KR) 10-2019-0122647

(51) Int. Cl. G09B 19/00; G09B 5/06

(52) U.S. Cl. CPC G09B 19/0053; G09B 5/065

(57) ABSTRACT

Provided is a coding education system including: a front server including a web server that provides a coding education content including Python IDE and virtual reality (VR) education using block coding or text coding, and a DB server that stores a plurality of data shared through the web server; a back server supporting a part or all of the coding education content with the front server; and a client terminal that accesses the front server and receives the coding education content.

### CROSS-REFERENCE TO RELATED APPLICATION(S)

The present application is a continuation of PCT international application No. PCT/KR2020/013345 filed on Sep. 29, 2020, and claims priority to Korean patent application No. 10-2019-0122647 filed on Oct. 2, 2019, the entire contents of which are hereby incorporated by reference.

### TECHNICAL FIELD

The present disclosure relates to a coding education system, and more particularly, relates to a coding education system that is easy to learn and practice coding education which is educated through a client terminal and may add interest to learning by providing a coding education content using block coding to the client terminal based on a Python integrated development environment (IDE) and a virtual reality (VR).

### BACKGROUND

Recently, as interest in coding education has increased, a service is provided for beginners, children, adolescents, or the like, through an application or a web server, which enables coding learning by providing a block-type command set and by arranging them, rather than directly dealing with programming languages.

As prior art, Korean Patent Registration No. 10-1966597, ‘Game type coding education method’, discloses a technology that provides more entertaining coding experience by combining a game, considering that students, who learn coding for the first time, may feel that coding is difficult or may easily lose interest.

As described above, for students learning coding for the first time, especially children, adolescents, or the like, there is a need for an interest-oriented coding education method that makes difficult coding familiar and easy.

### SUMMARY OF INVENTION

### Technical Problem

A problem to be solved by the present disclosure is to provide a coding education system that is easy to learn and practice coding education which is educated through a client terminal and may add interest to learning by providing a coding education content using block coding to the client terminal based on a Python IDE and a virtual reality (VR).

Problems to be solved by the present disclosure are not limited to the problems described above, and other problems not described will be clearly understood by those skilled in the art from the following description.

### Solution to Problem

According to an embodiment of the present disclosure to solve the problems described above, there is provided a coding education system including: a front server including a web server that provides a coding education content including Python IDE and virtual reality (VR) education using block coding or text coding, and a DB server that stores a plurality of data shared through the web server; a back server supporting a part or all of the coding education content with the front server; and a client terminal that accesses the front server and receives the coding education content.

Here, the coding education content may include a learning unit that provides coding education as a video for watching, provides a practice material based on the watched video, and calculates a practice score based on the provided practice material; a coding creation unit that provides a plurality of preset templates based on basic physics to create a coding work; and a sharing unit that shares the coding work created by the coding creation unit.

In addition, the back server may include a streaming server and a scoring engine server to support the coding education video of the learning unit through the streaming server, and support the calculation of the practice score through the scoring engine server.

In addition, the front server may further include an LMS unit that provides an interface to manage coding education related information of the client terminal for each class according to interworking of an instructor terminal according to an authority of an administrator terminal which manages the front server.

In addition, the coding education related information may include one or more of class management, progress management, attendance management, and evaluation management of the client terminal.

### Advantageous Effects

The coding education system according to an embodiment of the present disclosure has advantages in which it is easy to learn and practice the coding education which is educated through the client terminal and may add interest to learning by providing the coding education content using block coding to the client terminal based on the Python IDE and the virtual reality (VR).

### BRIEF DESCRIPTION OF THE DRAWINGS

FIG. 1 is a block diagram of a coding education system according to an embodiment of the present disclosure.

FIG. 2 is a configuration diagram of a coding education content provided through the coding education system of FIG. 1.

FIG. 3A is an exemplary view of education and practice of a Python IDE of the coding education system according to an embodiment of the present disclosure, and FIG. 3B is an exemplary view of education and practice of a virtual reality (VR) of the coding education system according to an embodiment of the present disclosure.

FIG. 4 is an exemplary view of a learning unit of the coding education content according to an embodiment of the present disclosure.

FIG. 5A is an exemplary view of a sharing unit that shares a coding work created based on Python IDE coding, and FIG. 5B is an exemplary view of a sharing unit that shares a coding work created based on a virtual reality (VR).

FIG. 6 is a view in which an interface of a coding education system used by an instructor through an instructor terminal is shown with blocks.

FIG. 7 is a diagram illustrating a dashboard state in the interface of FIG. 6.

FIG. 8 is a view in which an interface of a coding education system used by a learner through a client terminal is shown with blocks.

FIG. 9 is a view in which an interface of a coding education system used by an administrator through an administrator terminal is shown with blocks.

### BEST MODE FOR INVENTION

According to an embodiment of the present disclosure, there may be provided a coding education system including: a front server including a web server that provides a coding education content including Python IDE and virtual reality (VR) education using block coding or text coding, and a DB server that stores a plurality of data shared through the web server; a back server supporting a part or all of the coding education content with the front server; and a client terminal that accesses the front server and receives the coding education content.

### Detailed Description of Embodiments

Hereinafter, the description of the present disclosure with reference to the drawings is not limited to specific embodiments, various modifications may be made, and various embodiments may be provided. In addition, it should be understood that the contents described below include all transformations, equivalents, and substitutes included in the spirit and scope of the present disclosure.

In the following description, terms such as first, second, and the like are terms used to describe various configuration elements, meanings are not limited thereto, and are used only for the purpose of distinguishing one configuration element from other configuration elements.

Like reference numbers used throughout the present specification refer to like configuration elements.

As used herein, the singular expression includes the plural expression unless the context clearly dictates otherwise. In addition, terms such as “include”, “provide”, or “have” described below are intended to designate that the features, numbers, steps, operations, configuration elements, components, or combinations thereof described in the specification exist. It should be understood that this does not preclude the possibility of addition or existence of one or more other features, numbers, steps, operations, configuration elements, components, or combinations thereof.

In addition, terms such as “unit”, “portion”, “module”, and the like described in the specification mean a unit that processes at least one function or operation, which may be implemented as hardware, software, or a combination of hardware and software.

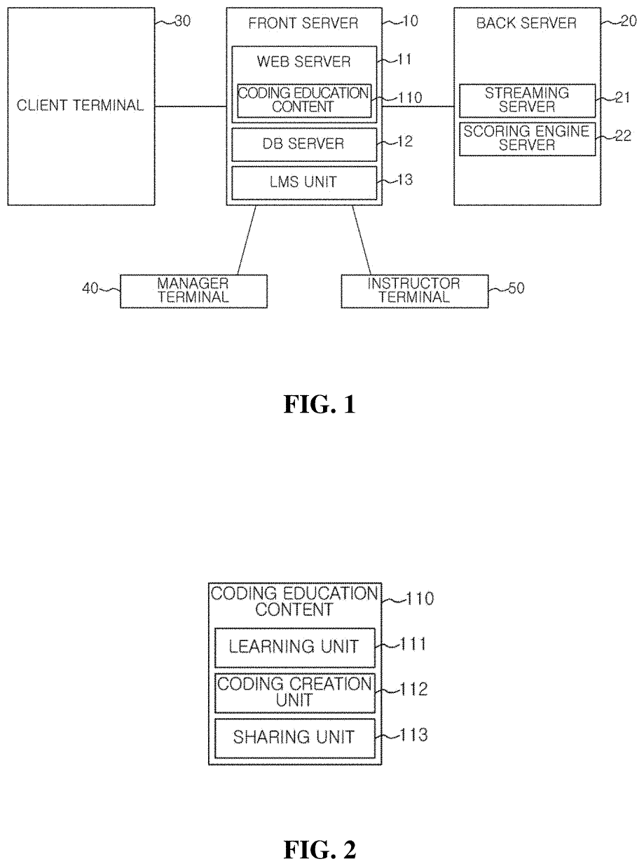

Hereinafter, a coding education system according to an embodiment of the present disclosure will be described in detail with reference to FIGS. 1 to 9.

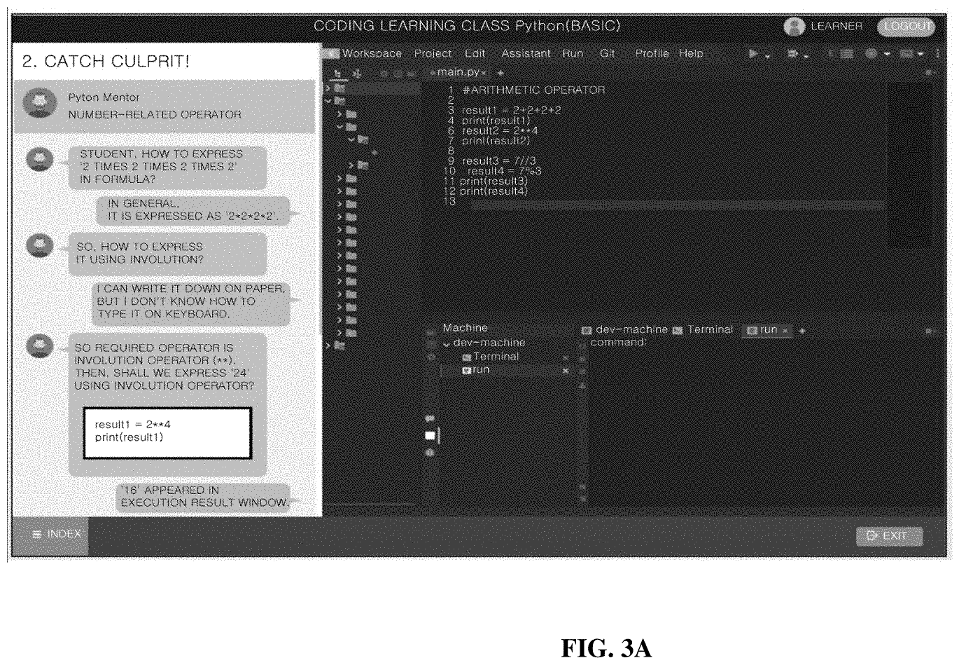

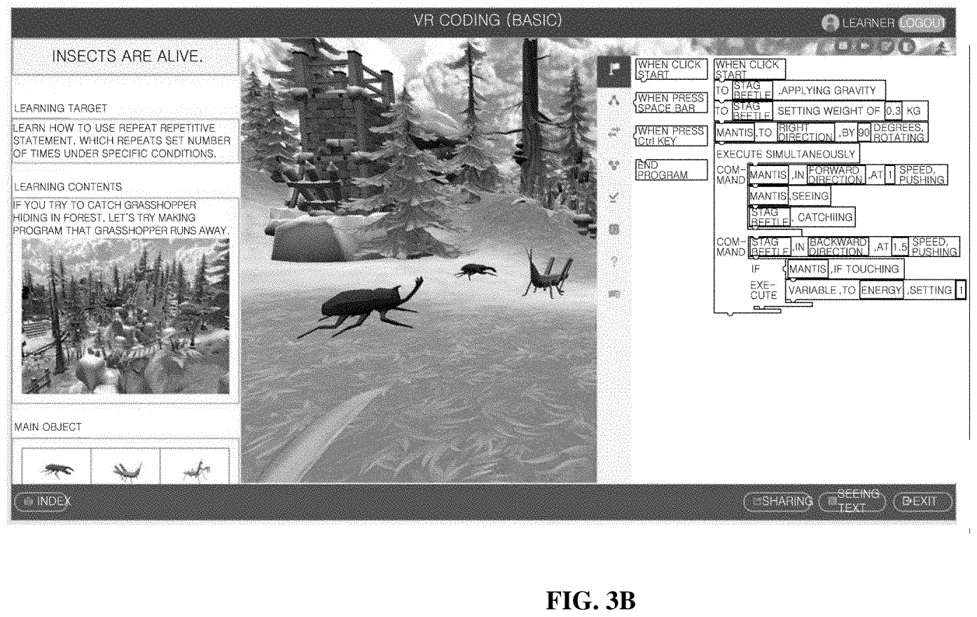

FIG. 1 is a block diagram of the coding education system according to the embodiment of the present disclosure, FIG. 2 is a configuration diagram of a coding education content provided through the coding education system of FIG. 1, FIG. 3A is an exemplary view of education and practice of a Python IDE of the coding education system according to the embodiment of the present disclosure, and FIG. 3B is an exemplary view of education and practice of a virtual reality (VR) of the coding education system according to the embodiment of the present disclosure.

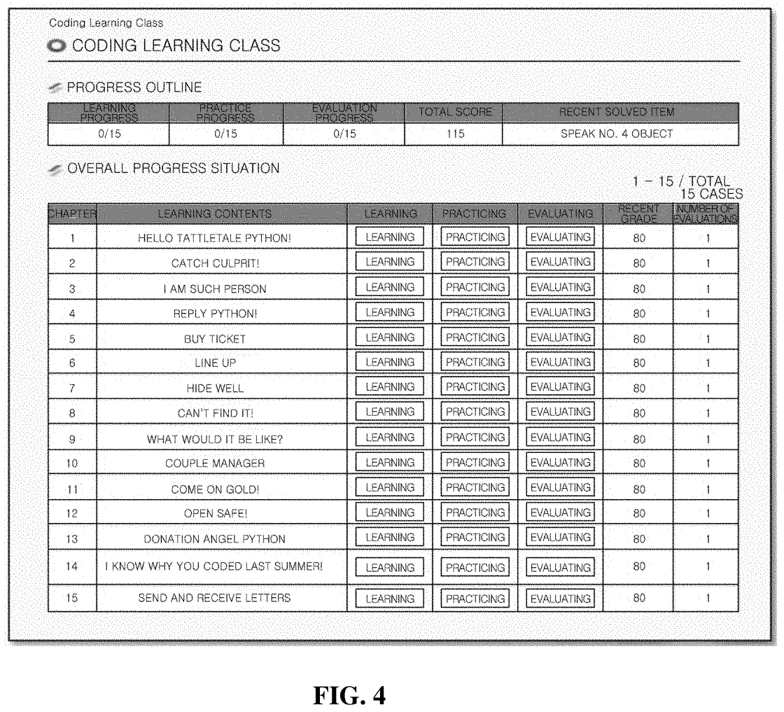

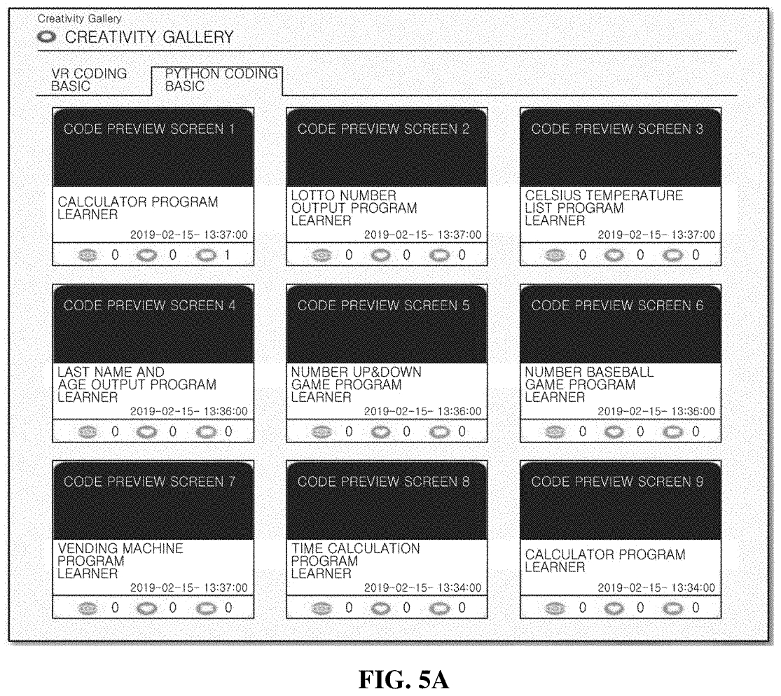

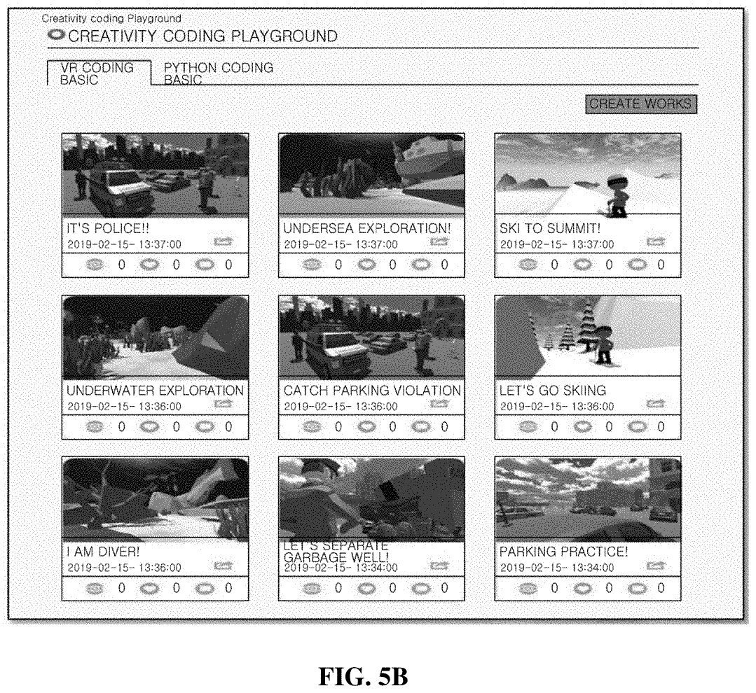

FIG. 4 is an exemplary view of a learning unit of the coding education content according to the embodiment of the present disclosure, FIG. 5A is an exemplary view of a sharing unit that shares a coding work created based on the Python IDE coding, and FIG. 5B is an exemplary view of a sharing unit that shares a coding work created based on the virtual reality (VR).

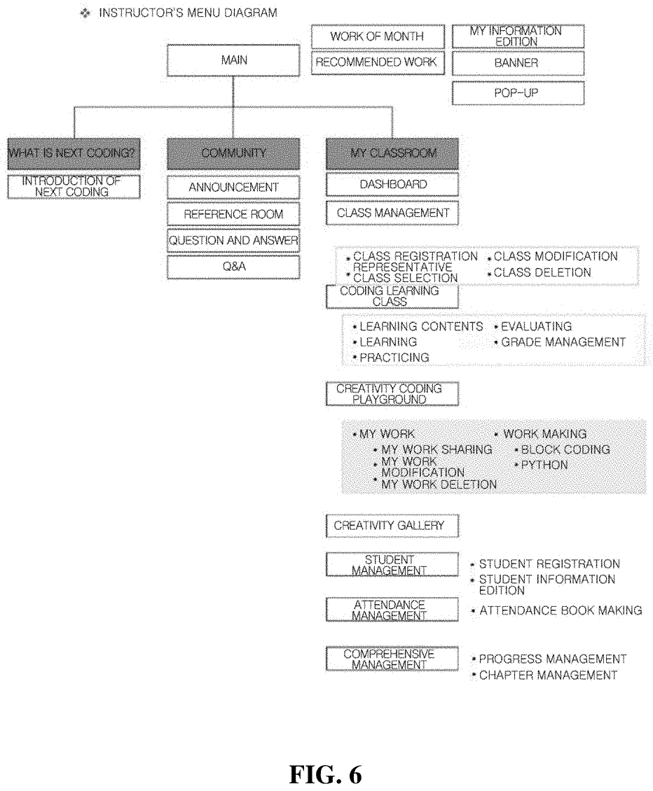

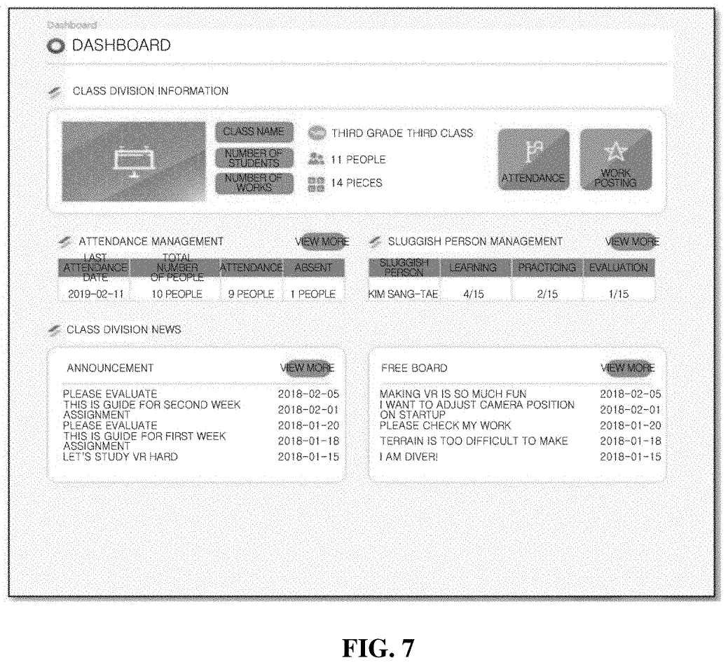

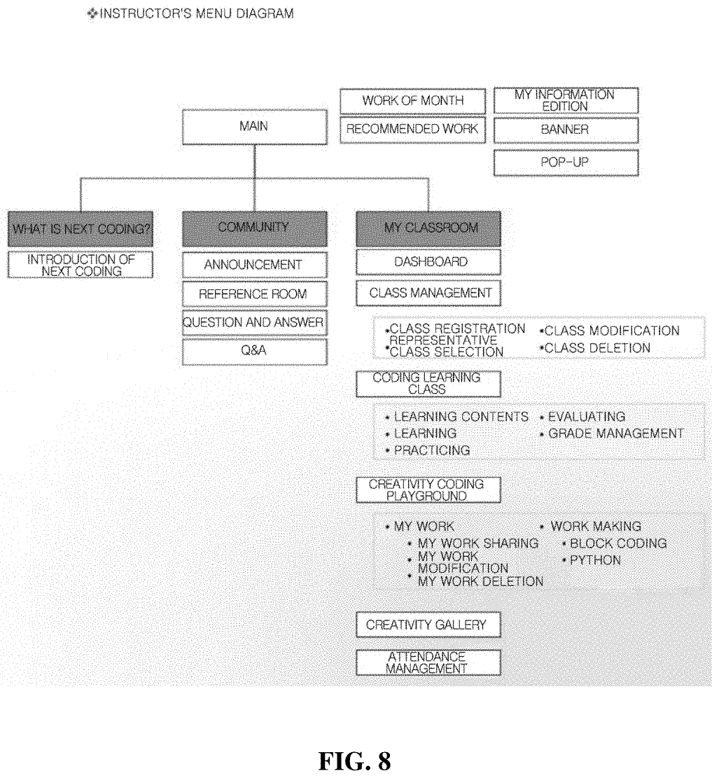

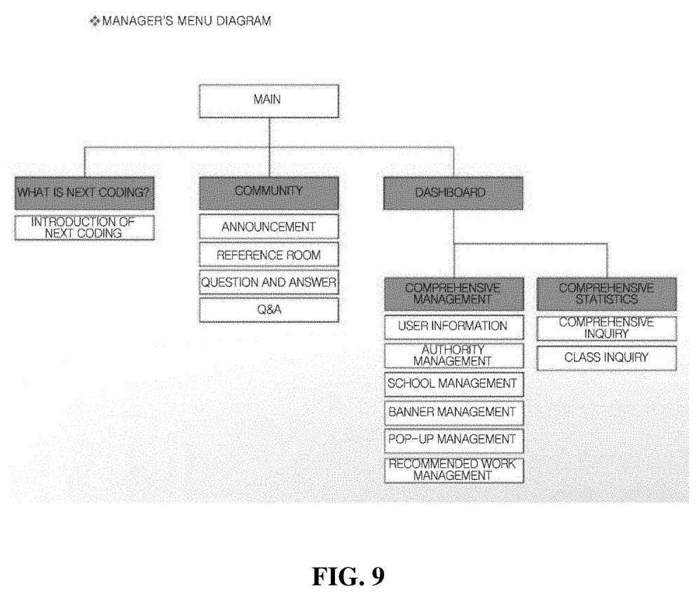

FIG. 6 is a view in which an interface of a coding education system used by an instructor through an instructor terminal is shown with blocks, FIG. 7 is a diagram illustrating a dashboard state in the interface of FIG. 6, FIG. 8 is a view in which an interface of a coding education system used by a learner through a client terminal is shown with blocks, and FIG. 9 is a view in which an interface of a coding education system used by an administrator through an administrator terminal is shown with blocks.

First, referring to FIGS. 1 to 9, the coding education system according to the embodiment of the present disclosure may be configured to include a front server 10, a back server 20, and a client terminal 30, and may further include an instructor terminal (50).

Specifically, the front server 10 and the back server 20 are servers provided to provide a coding education content 110, and the present disclosure forms a node JS (node js) structure to be divided into two servers.

The node JS structure is a technology that is configured of a front-end and a back-end. The front-end is visible to the user, such as web page design or button functions, and the back-end is a back-end technology that is invisible to the user. The node JS structure is a structure that allows the front-end to control the back-end with a script.

That is, the coding education system of the present disclosure formed in the node JS structure may be configured to implement the front end as the front server 10 and the back end as the back server 20, and to control from the front server 10 to the back server 20. In addition, the coding education system may be a form in which the front server 10 provides the coding education content 110, and the back server 20 supports some or all of the coding education content 110.

The front server 10 may be configured to include a web server 11 and a DB server 12.

As illustrated in FIGS. 3A and 3B, the web server 11 provides the coding education content 110 including Python IDE and virtual reality (VR) education using block coding or text coding, and the DB server 12 may store a plurality of data shared through the web server 11. The data shared through the web server 11 may be a practice score, a created coding work, or the like to be described later.

Here, the use of the block coding is to provide a block-type instruction set and arrange it to make coding learning or coding creation. By using such a block coding form, the coding education system of the present disclosure has an advantage of being easy to understand, learn, and use even for beginners, children, teenagers, and the like who do not have a good understanding of coding.

In this case, preferably, the block coding may be used in the virtual reality (VR) education, and the text coding may be used in the Python IDE education, but are not necessarily limited thereto, and may be used interchangeably.

The coding education content 110 may be configured to include a learning unit 111, a coding creation unit 112, and a sharing unit 113 as illustrated in FIG. 2.

Specifically, as illustrated in FIG. 4, the learning unit 111 may provide the coding education as a video for watching. In addition, the learning unit 111 may provide a practice material based on the watched video. In addition, the learning unit 111 may calculate a practice score based on the provided practice material.

Here, the learning unit 111 may provide for each function when providing the coding education as a video, and the functions may be provided, for example, by functions of a basic grammar, a graphic, an operator, a function, a control statement, a list, a repetitive statement, a dictionary, exception handling, file input/output, a class, a module, a package, and the like.

Specifically, the basic grammar may be learning about an output of characters, character string, and numbers with a PRINT statement, and learning about arithmetic operators that are used by looking at calculation results of the presented numbers. In addition, the graphic may be learning about making a window by using a GUI toolkit, making a work such as a picture of a specific artist by using a straight line in a window, or modifying and saving a timetable by using an external file.

In addition, the operator may be learning about characteristics of operators and variables by comparing values with various operators such as Boolean operation, logical operation, and comparison operation, and the function may be learning about an operation process of a function by calling a function that outputs a character string.

In addition, the control statement may be learning about an output a case where a specific value is input by using an IF-ELIF-ELSE syntax, and the list may be learning about configuring a new character string by finding a value stored in a list or understanding the character string as a list, and using indexing and slicing.

In addition, the repetitive statement may be learning about a process of evenly dividing elements by using repetitive statements such as for-in and while, and the dictionary may be learning about pairing a key and a value of a dictionary.

In addition, the exception handling may be learning about notifying an error with try-except when an error occurs, and the class, the module, and the package may be learning about use of a class or functions that use specific functions by calling the class, the module, and the package into a project.

As such, the learning unit 111 provides the learning video for each function, so that the learner receiving the coding education may easily understand and access the learning video.

Here, the learning unit 111 may notify the client terminal 30, which will be described later, of whether a practice score passes or does not reach a set reference value.

The learning unit 111 as described above may practice at the same time as learning, and may be evaluated after the practice, so that the learner may measure his/her coding skill and feels a sense of achievement, and find and learn missing parts.

In addition, as the web server 11 provides the coding education content 110 including the Python IDE and virtual reality (VR) education, the learning unit 111 may be formed to learn, practice, and receive evaluations for the Python IDE and virtual reality (VR) education, respectively.

The coding creation unit 112 may provide a plurality of preset templates based on basic physics to create a coding work such as a situation setting or a game.

Here, the basic physics refers to gravity, elasticity, acceleration, and the like, and the coding creation unit 112 may set situations such as separate collection and action tips in case of natural disasters, create game works such as a puzzle game, a catch game, and a running game, a calculator, and the like base thereon.

In addition, the coding creation unit 112 may perform the creation based on one of the Python IDE or virtual reality (VR) when creating a coding work such as setting the situations or the games as described above.

The sharing unit 113 is a space in which the coding works such as the situation setting or the games created by the coding creation unit 112 may be shared as illustrated in FIGS. 5A and 5B, and may be formed to share a subject of the coding work, meaning of the coding work, a coding code, and the like.

In this case, the sharing unit 113 may provide a chatbot capable of comments or conversations together, so that learners sharing through the sharing unit 113 may debate, discuss, and learn with each other.

In addition, the sharing unit 113 may measure the number of times of sharing or a degree of interest in the shared coding work, and give points to the learner or rank different levels, and the like to inspire participation in learning and give a sense of achievement.

In addition, the sharing unit 113 may set the coding work as excellent according to the degree of interest or the number of recommendations, display the coding work on a main screen or the like, or display a designated coding work on the main screen or the like through the instructor terminal 50.

The back server 20 is a backend technology of the above-described front server 10, and may support a part or all of the coding education content 110 with the front server 10. For example, a part of the coding education content 110 supported through the back server 20 may be a coding education video of the learning unit 111 and calculation of practice scores.

To this end, the back server 20 may include a streaming server 21 supporting the coding education video and a scoring engine server 22 supporting the calculation of practice scores.

Through the structure of the front server 10 and the back server 20, it may be easy to control the coding education contents 110 supported by the back server 20 through the front server 10 while data distribution is possible.

On the other hand, the coding education video and the calculation of the practice scores supported through the back server 20 are merely exemplary, and examples are not necessarily limited to these two, and as described above, all of the coding education contents 110 may be supported, and other coding education contents 110 in addition to the above-described these two may be supported.

The client terminal 30 is a terminal device such as a personal computer (PC), a tablet PC, or a mobile phone, which is possessed by the learner and provided with network communication means or an input/output device, and may be connected to the front server 10 to be provided with the coding education content provided from the front server 10.

In this case, the client terminal 30 is given different authentication IDs when initially connecting to the front server 10 so as not to cause a conflict among the client terminals 30, and a learning space of its own is provided, so that a function of continuously watching education video streaming, or the like may be possible.

The coding education system according to the embodiment of the present disclosure as described above has advantages in which it is easy to learn and practice the coding education about the Python IDE and virtual reality (VR), and adds interest to learning.

Meanwhile, the coding education system according to the embodiment of the present disclosure may further include the instructor terminal 50 as described above.

The instructor terminal 50 is a terminal used by the instructor to manage the learning of children or adolescents who access the client terminal 30, and the instructor terminal 50 may be interlocked with the front server 10 to manage coding education related information of the client terminal 30.

In this case, the front server 10 may further include an LMS unit 13 to provide an interface so that the instructor terminal 50 manages the client terminal 30 for each class.

Specifically, first, the LMS unit 13 may transmit subscription request information according to a subscription request to the manager terminal 40 that manages the front server 10 when there is the subscription request from the instructor terminal 50, and the manager terminal 40 may give an access code according to the subscription request and transmit it to the instructor terminal 50 so that the instructor terminal 50 may access the LMS unit 13.

In this case, the instructor terminal 50 may access the LMS unit 13 to create a class for the VR coding or the Python IDE coding subject, and manage one or more of class management, attendance management, progress management, and evaluation management for each class. Preferably, all of the above-described four managements may be performed.

Here, the class management may create classes, set a representative class for the created classes, and perform management such as activating or deactivating the class.

In addition, the class management is a form that includes student management, and may be configured to invite or add learners of the class, issue a temporary password of the learner, and manage exporting a class account or the like with Excel.

The attendance management is a space in which attendance for one class may be managed, the attendance of the learners may be viewed by inquiring by date, an attendance status may be exported with Excel, and a message may be delivered to a non-attendant in a form of conversation or e-mail.

The progress management is a space in which the overall progress of the learners may be checked, an evaluation status for practice materials for each learner may be checked, submitted practice materials may be checked one by one, and management of sending the submitted practice materials individually to the learners or sending them to each class by attaching comments to the submitted practice materials may be carried out.

The evaluation management may be formed to check the evaluation learned for each function, and the number of evaluations, the number of passes, or the like may be viewed.

One or more of the above-described four managements may be managed by the instructor terminal 50 for each class through the LMS unit 13, and thereby there are advantages that the management of the progress and learning may be easily performed even when many client terminals 30 are connected.

The interface connected through the instructor terminal 50 is as illustrated in FIG. 6.

In addition, as illustrated in FIG. 7, the LMS unit 13 may provide such management on the main screen in a form of a dashboard so that the management may be checked at a glance.

On the other hand, the LMS unit 13 may provide a management module for learning to the client terminal 30 using the front server 10 as well. A class management module for selecting or searching a class to apply for class participation, an attendance management module for class attendance, or the like may be provided.

An interface connected to the client terminal 30 is as illustrated in FIG. 8.

In addition, the above-described manager terminal 40 may be provided with a recommended work management module that recommends works as well as subscription and permission management of the learner and the instructor, a banner management module that may adjust the registration, modification, deletion, usage period setting, print order setting, or the like of banners, and a pop-up management module that may adjust the registration, modification, deletion, usage period setting, print order setting, or the like of pop-up, through the front server 10. In addition, the manager terminal 40 may be provided with a class inquiry, the total number of members, or the like through the LMS unit 13.

The interface connected to the manager terminal 40 is as illustrated in FIG. 9.

Although embodiments of the present disclosure have been described above with reference to the accompanying drawings, it will be able to understand that those of ordinary skill in the art to which the present disclosure pertains may practice the present disclosure in other specific forms without changing the technical spirit or essential features of the present disclosure. Accordingly, the embodiments described above are illustrative in all respects and not restrictive.

1. A coding education system comprising:
a front server comprising a web server providing a coding education content including Python IDE (Integrated Development Environment) and virtual reality (VR) education using block coding or text coding, and a database (DB) server storing a plurality of data shared through the web server;
a back server supporting a part or all of the coding education content to the front server; and
a client terminal accessing the front server and receiving the coding education content.

2. The coding education system according to claim 1, wherein the coding education content further comprises:
a learning unit providing a coding education video for watching and a practice material based on the coding education video, and calculating a practice score based on the provided practice material;
a coding creation unit providing a plurality of preset templates based on basic physics to create a coding work; and
a sharing unit sharing the coding work created by the coding creation unit.

3. The coding education system according to claim 2, wherein the back server comprises a streaming server and a scoring engine server, and
wherein the streaming server supports the coding education video of the learning unit, and the scoring engine server supports the calculation of the practice score.

4. The coding education system according to claim 1, wherein the front server further comprises a learning management system (LMS) unit providing an interface to manage coding education related information of the client terminal for each class according to interworking of an instructor terminal according to an authority of an administrator terminal which manages the front server.

5. The coding education system according to claim 4, wherein the coding education related information comprises one or more of class management, progress management, attendance management, and evaluation management of the client terminal.
